(19) United States
(12) Patent Application Publication
(10) Pub. No.: US 2022/0130025 A1
(43) Pub. Date: Apr. 28, 2022

(54) PICTURE OPTIMIZATION METHOD DEVICE, TERMINAL AND CORRESPONDING STORAGE MEDIUM

(71) Applicant: KANDAO TECHNOLOGY CO., LTD., Guangdong (CN)

(72) Inventors: Zhijing SHAO, Shenzhen (CN); Dan CHEN, Shenzhen (CN)

(73) Assignee: KANDAO TECHNOLOGY CO., LTD., Guangdong (CN)

(21) Appl. No.: 17/423,116

(22) PCT Filed: Jan. 14, 2020
(86) PCT No.: PCT/CN2020/071877

§ 371 Date: Dec. 2, 2021

(30) Foreign Application Priority Data
Jan. 15, 2019 (CN) 201910033929.7

(51) Int. Cl. G06T 5/50; G06T 5/00; G06T 7/33

(52) U.S. Cl. CPC G06T 5/50; G06T 5/002; G06T 7/337; G06T 2207/20201; G06T 2207/20221; G06T 2207/10016; G06T 2207/20056; G06T 5/003

(57) ABSTRACT

A picture optimization method, comprising: acquiring a target picture and a plurality of corresponding reference pictures (S101); dividing the target picture into a plurality of target picture alignment regions according to a set region size, adjacent target picture alignment regions having an overlapping region (S102); acquiring, on the basis of pixel gray scales a corresponding reference picture alignment region, in each reference picture, of each target picture alignment region in the target picture, and the similarity of each target picture alignment region in the target picture with the corresponding reference picture alignment region (S103); and performing, on the basis of the similarity , superposition and fusion on the corresponding target picture alignment regions of the target picture by using reference picture alignment regions of the plurality of reference pictures, so as to perform a noise reduction operation on the target picture (S104).

### TECHNICAL FIELD

The present invention relates to the field of image processing technologies, in particular to a picture optimizing method, device, a terminal, and a corresponding storage medium.

### DESCRIPTION OF RELATED ART

With the development of science and technology, people's demands on a picture shot by a handheld shooting terminal become higher and higher. For example, a user hopes that the definition of a shot photo becomes higher and higher, and shooting demands of the shooting terminal become lower and lower.

However, due to the design of miniaturization and portability of the handheld shooting terminal, people often perform a picture shooting operation by using the shooting terminal during exercise. In this way, the use convenience of the handheld shooting terminal is increased, and the handheld shooting terminal is used in more and more scenarios. However, an influence of hand motion on the handheld shooting terminal also becomes higher and higher, for example, the phenomenon of motion blur or picture ghost is easily caused in a picture shot by using an existing handheld shooting terminal.

Therefore, it is necessary to provide a picture optimizing method and device to solve problems existing in the prior art.

### SUMMARY OF THE INVENTION

### Technical Problem

Embodiments of the present invention provide a picture optimizing method and device capable of better eliminating the phenomenon of motion blur or picture ghost in a picture to solve the technical problem that the phenomenon of motion blur or picture ghost is easily caused in a shot picture under the influence of hand motion of a user in an existing picture optimizing method and a devices.

### SOLUTIONS OF THE PROBLEM

### Technical Solutions

An embodiment of the present invention provides a picture optimizing method, comprising:

acquiring a target picture and a plurality of corresponding reference pictures, wherein the target picture and the reference pictures are relevant pictures in the same region;

dividing the target picture into a plurality of target picture alignment regions according to a set region size, wherein the adjacent target picture alignment regions have overlapping regions;

acquiring a reference picture alignment region, corresponding to each of the target picture alignment regions in the target picture, in each of the reference pictures and similarities of the target picture alignment regions and the corresponding reference picture alignment regions based on pixel grayscales of the target picture and the reference pictures; and

superposing and fusing the reference picture alignment regions of the plurality of reference pictures and the corresponding target picture alignment regions of the target picture based on the similarities so as to perform a noise reduction operation on the target picture.

In one embodiment, the step of acquiring a reference picture alignment region, corresponding to each of the target picture alignment regions in the target picture, in each of the reference pictures based on pixel grayscales of the target picture and the reference pictures comprises:

A, using n set scales to generate n reduced target pictures according to the target picture and to generate n reduced reference pictures according to the reference pictures;

B, comparing pixel grayscales of reduced target pictures in a n^{th}-level set scale with pixel grayscales of reduced reference pictures in the n^{th}-level set scale to acquire corresponding regions of the reduced target pictures in the n^{th}-level set scale and the reduced reference pictures in the n^{th}-level set scale, wherein a m^{th}-level set scale is greater than a (m−1)^{th}-level set scale, and m and n are both positive integers;

C, comparing pixel grayscales of reduced target pictures in a previous-level set scale with pixel grayscales of reduced reference pictures in the previous-level set scale in the corresponding regions of the reduced target pictures in the n^{th}-level set scale and the reduced reference pictures in the n^{th}-level set scale to acquire corresponding regions of the reduced target pictures in the previous-level set scale and the reduced reference pictures in the previous-level set scale, and repeating the step C until corresponding regions of reduced target pictures in a first-level set scale and reduced reference pictures in the first-level set scale are acquired;

D, comparing a pixel grayscale of each of the target picture alignment regions in the target picture with a pixel grayscale of each of the reference pictures in the corresponding regions of the reduced target pictures in the first-level set scale and the reduced reference pictures in the first-level set scale to acquire the reference picture alignment region, corresponding to each of the target picture alignment regions in the target picture, in each of the reference pictures.

In one embodiment, the plurality of target picture alignment regions have the same shape, and the overlapping regions of the adjacent target picture alignment regions are greater than or equal to 50% of the region of the target picture alignment regions.

In one embodiment, the target picture and the reference pictures are continuously shot pictures for the same region within a set time or a plurality of continuous video picture frames displaying the same region within a set time.

In one embodiment, the step of superposing and fusing the reference picture alignment regions of the plurality of reference pictures and the corresponding target picture alignment regions of the target picture based on the similarities comprises:

generating a superposing and fusing weight of the corresponding reference picture based on the similarities of the target picture alignment regions and the reference picture alignment region of each of the reference pictures;

superposing and fusing the reference picture alignment regions of the plurality of reference pictures and the corresponding target picture alignment regions of the target picture based on the superposing and fusing weights of the reference pictures.

In one embodiment, the step of superposing and fusing the reference picture alignment regions of the plurality of reference pictures and the corresponding target picture alignment regions of the target picture based on the superposing and fusing weights of the reference pictures comprises:

performing discrete Fourier transform on the corresponding target picture alignment regions of the target picture to acquire target Fourier frequency spectrums of the target picture alignment regions;

performing discrete Fourier transform on the reference picture alignment regions of the reference pictures to acquire reference Fourier frequency spectrums of the reference picture alignment regions of the reference pictures;

performing weighted superposition on the target Fourier frequency spectrums of the target picture alignment regions by using the superposing and fusing weights of the reference pictures and the reference Fourier frequency spectrums of the reference picture alignment regions so as to obtain target Fourier frequency spectrums of superposed and fused target picture alignment regions;

performing an inverse discrete Fourier transform on the target Fourier frequency spectrums of the superposed and fused target picture alignment regions to obtain the superposed and fused target picture alignment regions.

In one embodiment, the picture optimizing method further comprises:

acquiring a brightness distribution diagram of the target picture subjected to the noise reduction operation;

performing a local brightness regulation on a region, where a brightness value is smaller than a set value, in the target picture subjected to the noise reduction operation.

An embodiment of the present invention further provides a picture optimizing device, comprising:

a relevant picture acquisition module, used for acquiring a target picture and a plurality of corresponding reference pictures, wherein the target picture and the reference pictures are relevant pictures in the same region;

an region division module, used for dividing the target picture into a plurality of target picture alignment regions according to a set region size, wherein the adjacent target picture alignment regions have overlapping regions;

a comparison module, used for acquiring a reference picture alignment region, corresponding to each of the target picture alignment regions in the target picture, in each of the reference pictures and similarities of the target picture alignment regions and the corresponding reference picture alignment regions based on pixel grayscales of the target picture and the reference pictures; and

an optimization module, used for superposing and fusing the reference picture alignment regions of the plurality of reference pictures and the corresponding target picture alignment regions of the target picture based on the similarities so as to perform a noise reduction operation on the target picture.

An embodiment of the present invention further provides a computer readable storage medium, storing instructions executable by a processor, wherein the instructions are loaded by one or more processors so that the above-mentioned picture optimizing method is performed.

An embodiment of the present invention further provides a terminal, comprising a processor and a memory, wherein the memory stores a plurality of instructions, and the processor loads the instructions from the memory so as to perform the above-mentioned picture optimizing method.

### Advantageous Effects of The Invention

### Advantageous Effects

Compared with a picture optimizing method and device in the prior art, the picture optimizing method and device in the present invention has the beneficial effects that the target picture is optimized by using the plurality of reference pictures, so that interference information in the target picture can be better eliminated, then, the phenomenon of motion blur in the picture can be effectively eliminated, and meanwhile, the phenomenon of picture ghost can be eliminated; and the technical problem that the phenomenon of motion blur or picture ghost is easily caused in a shot picture under the influence of hand motion of a user in the existing picture optimizing method and device is effectively solved.

### BRIEF DESCRIPTION OF THE DRAWINGS

FIG. 1 is a flow diagram of a first embodiment of a picture optimizing method provided by the present invention;

FIG. 2 is a flow diagram of step S103 in the first embodiment of the picture optimizing method provided by the present invention;

FIG. 3 is a flow diagram of step S104 in the first embodiment of the picture optimizing method provided by the present invention;

FIG. 4 is a flow diagram of step S302 in the first embodiment of the picture optimizing method provided by the present invention;

FIG. 5 is a flow diagram of a second embodiment of the picture optimizing method provided by the present invention;

FIG. 6a is a schematic diagram of a target picture which is not subjected to local brightness regulation;

FIG. 6b is a schematic diagram of a target picture of which a dark part region is subjected to local brightness regulation;

FIG. 7 is a structural schematic diagram of a first embodiment of a picture optimizing device provided by the present invention;

FIG. 8 is a structural schematic diagram of a second embodiment of the picture optimizing device provided by the present invention;

FIG. 9 is a schematic diagram showing a structure of a working environment of an electronic device where the picture optimizing device provided by the present invention is located.

### THE BEST EMBODIMENT FOR IMPLEMENTING THE INVENTION The best implementation of the present invention

The technical solutions in embodiments of the present invention will be clearly and completely described below with reference to the accompanying drawings in the embodiments of the present invention. Obviously, the described embodiments are only a part of embodiments instead of all embodiments of the present invention. All other embodiments obtained by a person of ordinary skill in the art based on the embodiments of the present invention without creative effects shall fall within the protection scope of the present invention.

A picture optimizing method and device provided by the present invention are used in an electronic device capable of continuously shooting pictures or shooting a video. The electronic device includes, but is not limited to a wearable device, a head-mounted device, a medical health platform, a personal computer, a server computer, a handheld or laptop device, a mobile device (such as a mobile phone, a personal digital assistant (PDA) and a media player), a multi-processor system, a consumer electronic device, a small-size computer, a large-scale computer, and a distributed computing environment comprising any above-mentioned systems or devices. The electronic device is preferably an electronic shooting terminal capable of shooting photos or videos so that pictures are continuously shot or a video is shot. According to the electronic device, a target picture can be optimized by using a plurality of reference pictures, so that interference information in the target picture can be better eliminated, then, the phenomenon of motion blur in the picture can be effectively eliminated, and meanwhile, the phenomenon of picture ghost can be eliminated.

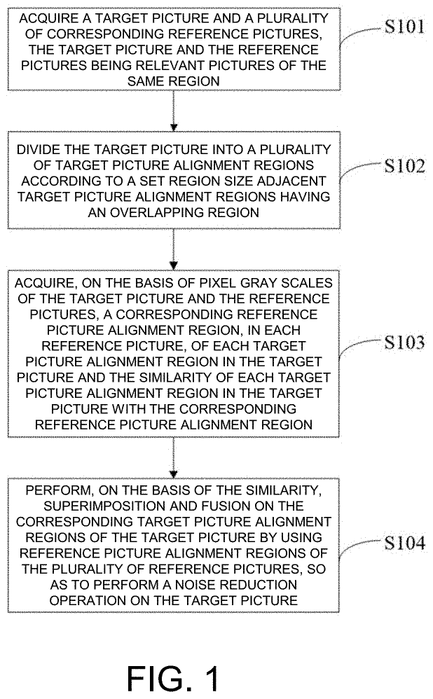

Reference is made to FIG. 1 which is a flow diagram of a first embodiment of a picture optimizing method provided by the present invention. The picture optimizing method in the present embodiment can be performed by using the above-mentioned electronic device. The picture optimizing method comprises:

step S101, acquiring a target picture and a plurality of corresponding reference pictures, wherein the target picture and the reference pictures are relevant pictures in the same region;

step S102, dividing the target picture into a plurality of target picture alignment regions according to a set region size, wherein the adjacent target picture alignment regions have overlapping regions;

step S103, acquiring a reference picture alignment region, corresponding to each of the target picture alignment regions in the target picture, in each of the reference pictures and similarities of the target picture alignment regions and the corresponding reference picture alignment regions based on pixel grayscales of the target picture and the reference pictures;

step S104, superposing and fusing the reference picture alignment regions of the plurality of reference pictures and the corresponding target picture alignment regions of the target picture based on the similarities so as to perform a noise reduction operation on the target picture.

Specific flow of all the steps of the picture optimizing method in the present embodiment will be described below in detail.

In the step S101, a picture optimizing device (such as an electronic shooting terminal) acquires the target picture and the plurality of corresponding reference pictures. The acquired reference pictures are intended to optimize the target picture, and therefore, the target picture and the reference pictures should be the relevant pictures in the same region.

Specifically, the target picture and the reference pictures can be continuously shot pictures (continuously shot photos) for the same region within a set time or a plurality of continuous video picture frames (video) displaying the same region within a set time. Therefore, the reference pictures and the target picture should have a great number of contents relevant to the same region, and thus the target picture can be optimized by using the reference pictures.

In the step S102, the picture optimizing device performs a division operation on the target picture according to the set region size which is preset. Specifically, the target picture is divided into the plurality of target picture alignment regions, and the adjacent target picture alignment regions have overlapping regions.

Wherein the plurality of target picture alignment regions have the same shape, and the overlapping regions of the adjacent target picture alignment regions are greater than or equal to 50% of the region of the target picture alignment regions. The target picture appears twice or more times in all the target picture alignment regions, in this way, errors subsequently generated when the target picture alignment regions and the reference pictures are matched can be better reduced.

In the step S103, the picture optimizing device acquires a reference picture alignment region, corresponding to each of the target picture alignment regions in the target picture, in each of the reference pictures and similarities of the target picture alignment regions and the corresponding reference picture alignment regions based on pixel grayscales of the target picture and the reference pictures.

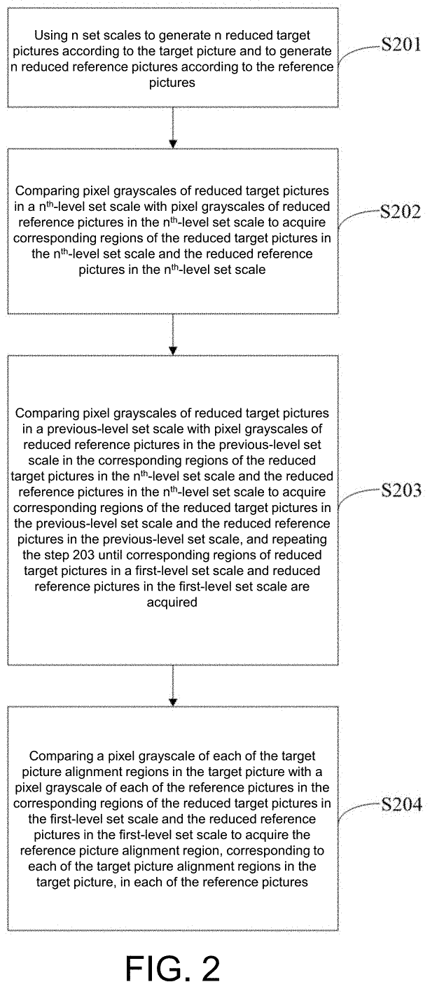

Specifically, a flow of acquiring the target picture alignment regions and the corresponding reference picture alignment regions refers to FIG. 2 which is a flow diagram of the step S103 in the first embodiment of the picture optimizing method provided by the present invention. The step S103 comprises:

Step S201, using n set scales to generate n reduced target pictures according to the target picture and to generate n reduced reference pictures according to the reference pictures. For example, herein, the target picture can be reduced by 2 times, 4 times, 8 times and the like to acquire the n reduced target pictures; and the reference pictures are reduced by 2 times, 4 times, 8 times and the like to acquire the n reduced reference pictures.

Step S202, comparing pixel grayscales of reduced target pictures in a n^{th}-level set scale with pixel grayscales of reduced reference pictures in the n^{th}-level set scale to acquire corresponding regions of the reduced target pictures in the n^{th}-level set scale and the reduced reference pictures in the n^{th}-level set scale, wherein a m^{th}-level set scale is greater than a (m−1)^{th}-level set scale, and m and n are both positive integers.

Herein, it is possible that a third-level set scale is set as 8 times, a second-level set scale is set as 4 times, and the first-level set scale is set as 2 times. In this step, pixel grayscales of reduced target pictures in the third-level set scale are compared with pixel grayscales of reduced reference pictures in the third-level set scale to acquire corresponding regions of the reduced target pictures in the third-level set scale and the reduced reference pictures in the third-level set scale. Herein, region division can be performed on the reduced target pictures in the third-level set scale, and then, a traversal operation is sequentially performed on the reduced reference pictures in the third-level set scale according to the divided regions, so that corresponding regions of all the divided regions of the reduced target pictures in the third-level set scale and the reduced reference pictures in the third-level set scale are acquired. The compared regions of the reduced target pictures and the reduced reference pictures in the set scale which is 8 times are relatively small, and therefore, the comparison of the pixel grayscales can be better accelerated.

Step S203, comparing pixel grayscales of reduced target pictures in a previous-level set scale with pixel grayscales of reduced reference pictures in the previous-level set scale in the corresponding regions of the reduced target pictures in the n^{th}-level set scale and the reduced reference pictures in the n^{th}-level set scale to acquire corresponding regions of the reduced target pictures in the previous-level set scale and the reduced reference pictures in the previous-level set scale, and repeating a step C until corresponding regions of reduced target pictures in a first-level set scale and reduced reference pictures in the first-level set scale are acquired.

For example, in the corresponding regions of the reduced target pictures in the third-level set scale and the reduced reference pictures in the third-level set scale, pixel grayscales of reduced target pictures in a second-level set scale are compared with pixel grayscales of reduced reference pictures in the second-level set scale, herein, region division can be performed on the reduced target pictures in the second-level set scale, and then, a traversal operation is sequentially performed on the reduced reference pictures in the second-level set scale according to the divided regions, so that corresponding regions of all the divided regions of the reduced target pictures in the second-level set scale and the reduced reference pictures in the second-level set scale are acquired, and then, corresponding regions of the reduced target pictures in the second-level set scale and the reduced reference pictures in the second-level set scale are acquired.

Then, in the corresponding regions of the reduced target pictures in the second-level set scale and the reduced reference pictures in the second-level set scale, pixel grayscales of the reduced target pictures in the first-level set scale are compared with pixel grayscales of the reduced reference pictures in the first-level set scale, herein, region division can be performed on the reduced target pictures in the first-level set scale, and then, a traversal operation is sequentially performed on the reduced reference pictures in the first-level set scale according to the divided regions, so that corresponding regions of all the divided regions of the reduced target pictures in the first-level set scale and the reduced reference pictures in the first-level set scale are acquired, and then, the corresponding regions of the reduced target pictures in the first-level set scale and the reduced reference pictures in the first-level set scale are acquired.

Step S204, comparing a pixel grayscale of each of the target picture alignment regions in the target picture with a pixel grayscale of each of the reference pictures in the corresponding regions of the reduced target pictures in the first-level set scale and the reduced reference pictures in the first-level set scale, wherein, herein, a traversal operation can be sequentially performed on each of the reference pictures according to the target picture alignment regions in the target picture, thereby acquiring the reference picture alignment region, corresponding to each of the target picture alignment regions in the target picture, in each of the reference pictures.

In the steps S202 to S204, the reference picture alignment regions corresponding to the target picture alignment regions are generated by virtue of multi-level reduced target pictures and multi-level reduced reference pictures, so that the acquisition of the corresponding reference picture alignment regions can be accelerated, and the calculated amount for acquiring the reference picture alignment regions can be reduced. For a comparison operation described herein, a displacement compensation operation can be performed on small deviations generated on the target picture due to hand shake during shooting.

After the target picture alignment regions and the corresponding reference picture alignment regions are acquired, the similarities of the target picture alignment regions and the corresponding reference picture alignment regions are determined based on the pixel grayscales of the target picture alignment regions and the pixel grayscales of the corresponding reference picture alignment regions. The higher the consistence of the pixel grayscales of the target picture alignment regions and the pixel grayscales on corresponding positions of the corresponding reference picture alignment regions are, the higher the similarities of the target picture alignment regions and the corresponding reference picture alignment regions are.

In the step S104, the picture optimizing device superposes and fuses the reference picture alignment regions of the plurality of reference pictures and the corresponding target picture alignment regions of the target picture based on the similarities, acquired in the step S103, of the target picture alignment regions and the corresponding reference picture alignment regions so as to perform a noise reduction operation on the target picture.

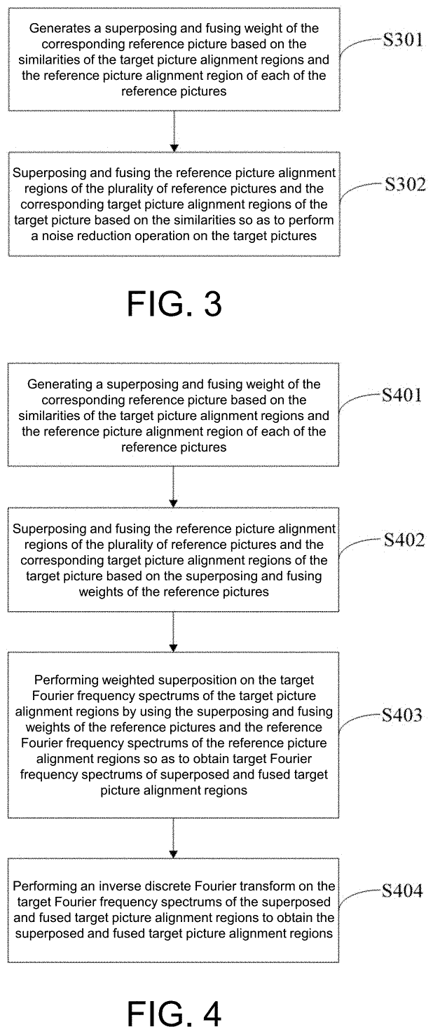

Specifically, reference is made to FIG. 3 which is a flow diagram of the step S104 in the first embodiment of the picture optimizing method provided by the present invention. The step S104 comprises:

Step S301, the picture optimizing device generates a superposing and fusing weight of the corresponding reference picture based on the similarities of the target picture alignment regions and the reference picture alignment region of each of the reference pictures.

The superposing and fusing weight described herein refer to a weight relationship that the reference picture alignment regions of the plurality of reference pictures are fused into the corresponding target picture alignment regions. The reference picture alignment regions and the target picture alignment regions which have relatively low similarities have relatively great differences and relatively small effects on optimizing and correcting the target picture alignment regions, and therefore, the corresponding superposing and fusing weights are relatively small. The reference picture alignment regions and the target picture alignment regions which have relatively high similarities have relatively small differences and relatively large effects on optimizing and correcting the target picture alignment regions, and therefore, the corresponding superposing and fusing weights are relatively large.

Step S302, the picture optimizing device superposes and fuses the reference picture alignment regions of the plurality of reference pictures and the corresponding target picture alignment regions of the target picture based on the superposing and fusing weights, acquired in the step S301, of the reference pictures. Specifically, reference is made to FIG. 4 which is a flow diagram of the step S302 in the first embodiment of the picture optimizing method provided by the present invention. The step S302 comprises:

Step S401, the picture optimizing device performs discrete Fourier transform on the corresponding target picture alignment regions of the target picture to acquire target Fourier frequency spectrums of the target picture alignment regions.

Step S402, the picture optimizing device performs discrete Fourier transform on the reference picture alignment regions of the reference pictures to acquire reference Fourier frequency spectrums of the reference picture alignment regions of the reference pictures. In this way, the reference picture alignment regions and the target picture alignment regions can be effectively superposed and fused by using the Fourier frequency spectrums.

Step S403, performing weighted superposition on the target Fourier frequency spectrums of the target picture alignment regions by using the superposing and fusing weights, acquired in the step S301, of the reference pictures and the reference Fourier frequency spectrums of the reference picture alignment regions so as to obtain target Fourier frequency spectrums of superposed and fused target picture alignment regions.

Step S404, performing an inverse discrete Fourier transform on the target Fourier frequency spectrums, acquired in the step S403, of the superposed and fused target picture alignment regions to obtain the superposed and fused target picture alignment regions.

Herein, the target picture and the plurality of reference pictures are superposed and fused, generally, true signals of the pictures cannot be changed during continuous shooting or in continuous video frames, but noise signals really occur randomly in the reference pictures or the target picture, and therefore, the target picture is optimized by being superposed and fused with the plurality of reference pictures, in this way, the noise reduction operation on the target picture can be effectively achieved.

In this way, a noise reduction optimization process achieved by using the picture optimizing method in the present embodiment for the target picture is completed.

According to the picture optimizing method in the present embodiment, the target picture is optimized by using the plurality of reference pictures, so that interference information in the target picture can be better eliminated, then the phenomenon of motion blur in the picture can be effectively eliminated, and meanwhile, the phenomenon of picture ghost can be eliminated.

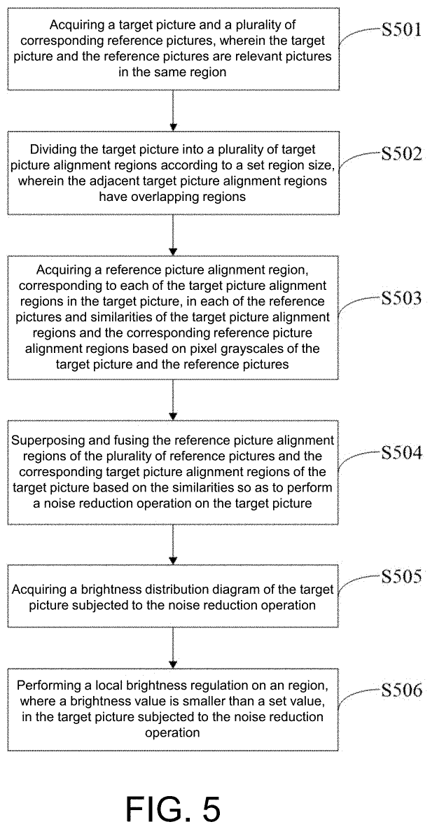

Reference is made to FIG. 5 which is a flow diagram of a second embodiment of the picture optimizing method provided by the present invention. The picture optimizing method in the present embodiment can be performed by using the above-mentioned electronic device. The picture optimizing method comprises:

step S501, acquiring a target picture and a plurality of corresponding reference pictures, wherein the target picture and the reference pictures are relevant pictures in the same region;

step S502, dividing the target picture into a plurality of target picture alignment regions according to a set region size, wherein the adjacent target picture alignment regions have overlapping regions;

step S503, acquiring a reference picture alignment region, corresponding to each of the target picture alignment regions in the target picture, in each of the reference pictures and similarities of the target picture alignment regions and the corresponding reference picture alignment regions based on pixel grayscales of the target picture and the reference pictures;

step S504, superposing and fusing the reference picture alignment regions of the plurality of reference pictures and the corresponding target picture alignment regions of the target picture based on the similarities so as to perform a noise reduction operation on the target picture;

step S505, acquiring a brightness distribution diagram of the target picture subjected to the noise reduction operation;

step S506, performing a local brightness regulation on a region, where a brightness value is smaller than a set value, in the target picture subjected to the noise reduction operation.

Specific flow of all the steps of the picture optimizing method in the present embodiment will be described below in detail.

The steps S501 to S504 in the present embodiments are the same or similar to relevant descriptions in the steps S101 to S104 in the first embodiment of the above-mentioned picture optimizing method, and for details, refer to the relevant descriptions in the steps S101 to S104 in the first embodiment of the above-mentioned picture optimizing method.

In the step S505, after the picture optimizing device in the present embodiment performs the noise reduction operation, the overall noise of the target picture has been reduced, and therefore, a local contrast regulation can be performed on the target picture to improve the detail exhibition ability of the target picture.

In this step, the picture optimizing device acquires the brightness distribution diagram of the target picture subjected to the noise reduction operation so as to regulate the contrast of the target picture according to brightness.

In the step S506, the picture optimizing device performs the local brightness regulation on the region, where the brightness value is smaller than the set value, in the target picture subjected to the noise reduction operation. That is, a pixel brightness of the region where the brightness value is smaller than the set value is multiplied by a coefficient greater than 1, so that a brightening operation is performed on the region by using a dark part brightening method, and then, the detail exhibition ability of the region is improved. Since the overall noise of the target picture is relatively small, influences of noise of the target picture on the picture exhibition ability of a brightened region are quite limited.

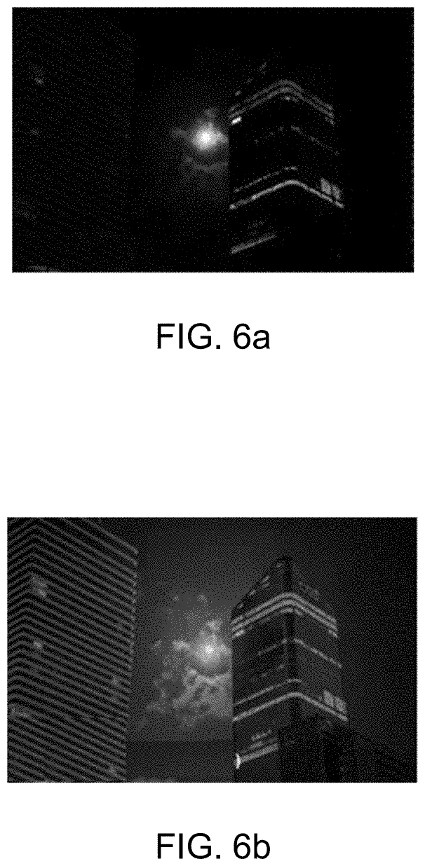

For details, reference can be made to FIG. 6a and FIG. 6b, wherein FIG. 6a is a schematic diagram of a target picture which is not subjected to local brightness regulation, and FIG. 6b is a schematic diagram of a target picture of which a dark part region is subjected to local brightness regulation. It can be obviously seen from the figures that the detail exhibition ability in FIG. 6b is stronger than that in FIG. 6a.

In this way, a picture optimizing process, achieved by using the picture optimizing method in the present embodiment, for the target picture is completed.

Based on the first embodiment, the local brightening operation is performed on the noise-reduced target picture by using the picture optimizing method in the present embodiment, so that the detail exhibition ability and color saturation of the target picture are further improved.

The present invention further provides a picture optimizing device. Reference is made to

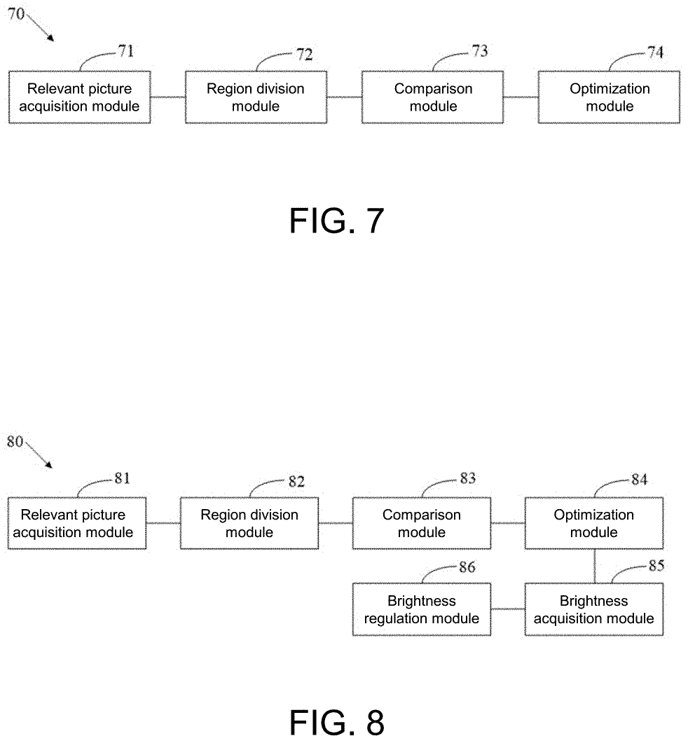

FIG. 7 which is a structural schematic diagram of a first embodiment of the picture optimizing device provided by the present invention. The picture optimizing device in the present embodiment can be performed by the first embodiment of the above-mentioned picture optimizing method. The picture optimizing device 70 in the present embodiment comprises a relevant picture acquisition module 71, a region division module 72, a comparison module 73 and an optimization module 74.

The relevant picture acquisition module 71 is used for acquiring a target picture and a plurality of corresponding reference pictures, wherein the target picture and the reference pictures are relevant pictures in the same region; the region division module 72 is used for dividing the target picture into a plurality of target picture alignment regions according to a set region size, wherein the adjacent target picture alignment regions have overlapping regions; the comparison module 73 is used for acquiring a reference picture alignment region, corresponding to each of the target picture alignment regions in the target picture, in each of the reference pictures and similarities of the target picture alignment regions and the corresponding reference picture alignment regions based on pixel grayscales of the target picture and the reference pictures; and the optimization module 74 is used for superposing and fusing the reference picture alignment regions of the plurality of reference pictures and the corresponding target picture alignment regions of the target picture based on the similarities so as to perform a noise reduction operation on the target picture.

When the picture optimizing device 70 in the present embodiment is used, firstly, the relevant picture acquisition module 71 acquires the target picture and the plurality of corresponding reference pictures, wherein the acquired reference pictures are intended to optimize the target picture, and therefore, the target picture and the reference pictures should be the relevant pictures in the same region.

Then, the region division module 72 performs a division operation on the target picture and the reference pictures according to the set region size which is preset. Specifically, the target picture is divided into the plurality of target picture alignment regions, and the adjacent target picture alignment regions have the overlapping regions.

Wherein the plurality of target picture alignment regions have the same shape, and the overlapping regions of the adjacent target picture alignment regions are greater than or equal to 50% of the region of the target picture alignment regions. The target picture appears twice or more times in all the target picture alignment regions, in this way, errors subsequently generated when the target picture alignment regions and the reference pictures are matched can be better reduced.

Then, the comparison module 73 acquires the reference picture alignment region, corresponding to each of the target picture alignment regions in the target picture, in each of the reference pictures and the similarities of the target picture alignment regions and the corresponding reference picture alignment regions based on the pixel grayscales of the target picture and the reference pictures.

Finally, the optimization module 74 superposes and fuses the reference picture alignment regions of the plurality of reference pictures and the corresponding target picture alignment regions of the target picture based on the acquired similarities of the target picture alignment regions and the corresponding reference picture alignment regions so as to perform the noise reduction operation on the target picture.

In this way, a noise reduction optimizing process, achieved by the picture optimizing device 70 in the present embodiment, for the target picture is completed.

The specific working principle of the picture optimizing device in the present embodiment is the same or similar to descriptions in the first embodiment of the above-mentioned picture optimizing method, and specifically refers to the relevant descriptions in the first embodiment of the above-mentioned picture optimizing method.

According to the picture optimizing method in the present embodiment, the target picture is optimized by using the plurality of reference pictures, so that interference information in the target picture can be better eliminated, then, the phenomenon of motion blur in the picture can be effectively eliminated, and meanwhile, the phenomenon of picture ghost can be eliminated.

Reference is made to FIG. 8 which is a structural schematic diagram of a second embodiment of the picture optimizing device provided by the present invention. The picture optimizing device in the present embodiment can be performed by the second embodiment of the above-mentioned picture optimizing method. The picture optimizing device 80 in the present embodiment comprises a relevant picture acquisition module 81, a region division module 82, a comparison module 83, an optimization module 84, a brightness acquisition module 85 and a brightness regulation module 86.

The relevant picture acquisition module 81 is used for acquiring a target picture and a plurality of corresponding reference pictures, wherein the target picture and the reference pictures are relevant pictures in the same region; the region division module 82 is used for dividing the target picture into a plurality of target picture alignment regions according to a set region size, wherein the adjacent target picture alignment regions have overlapping regions; the comparison module 83 is used for acquiring a reference picture alignment region, corresponding to each of the target picture alignment regions in the target picture, in each of the reference pictures and similarities of the target picture alignment regions and the corresponding reference picture alignment regions based on pixel grayscales of the target picture and the reference pictures; the optimization module 84 is used for superposing and fusing the reference picture alignment regions of the plurality of reference pictures and the corresponding target picture alignment regions of the target picture based on the similarities so as to perform a noise reduction operation on the target picture; the brightness acquisition module 85 is used for acquiring a brightness distribution diagram of the target picture subjected to the noise reduction operation; and the brightness regulation module 86 is used for performing a local brightness regulation on an region, where a brightness value is smaller than a set value, in the target picture subjected to the noise reduction operation.

Based on the first embodiment of the picture optimizing device, the picture optimizing device 80 in the present embodiment further comprises the brightness acquisition module 85 which acquires the brightness distribution diagram of the target picture subjected to the noise reduction operation so as to regulate the contrast of the target picture according to brightness. Then, the brightness regulation module 86 performs the local brightness regulation on the region, where the brightness value is smaller than the set value, in the target picture subjected to the noise reduction operation. That is, a pixel brightness of the region where the brightness value is smaller than the set value is multiplied by a coefficient greater than 1, so that a brightening operation is performed on the region by using a dark part brightening method, and then, the detail exhibition ability of the region is improved. Since the overall noise of the target picture is relatively small, influences of noise of the target picture on the picture exhibition ability of a brightened region are quite limited.

In this way, a picture optimizing process achieved by using the picture optimizing device 80 in the present embodiment for the target picture is completed.

Based on the first embodiment, the local brightening operation is performed on the noise-reduced target picture by using the picture optimizing device in the present embodiment, so that the detail exhibition ability and color saturation of the target picture are further improved.

According to the picture optimizing method and device in the present invention, the target picture is optimized by using the plurality of reference pictures, so that interference information in the target picture can be better eliminated, then, the phenomenon of motion blur in the picture can be effectively eliminated, and meanwhile, the phenomenon of picture ghost can be eliminated; and the technical problem that the phenomenon of motion blur or picture ghost is easily caused in a shot picture under the influence of hand motion of a user in the existing picture optimizing method and device is effectively solved.

Terms such as “component”, “module”, “system”, “interface” and “process” used in the present application generally refer to computer-relevant entities: hardware, a combination of hardware and software, software or software being executed. For example, the component can be, but not limited to a process running on a processor, the processor, an object, an executable application, an executed thread, a program and/or a computer. Shown by the drawings, an application running on a controller and the controller can be both components. One or more components can exist in the executed process and/or thread and can be located on one computer and/or distributed between two computers or among more computers.

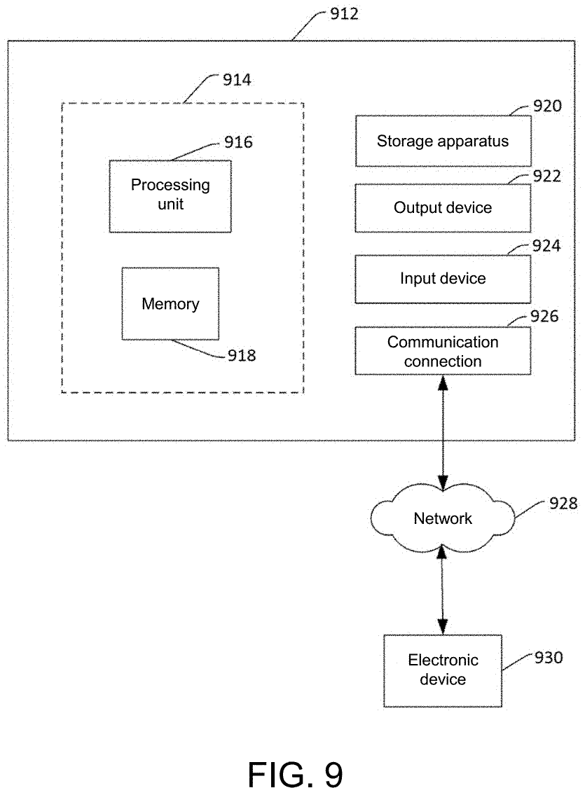

FIG. 9 and the subsequent discussion provide brief and general descriptions for a working environment of an electronic device where the picture optimizing device provided by the present invention is located. The working environment shown in FIG. 9 is only an example of an appropriate working environment and is not intended to constitute any limitations on the range of applications or functions of the working environment. An exemplary electronic device 912 comprises, but is not limited to, a wearable device, a head-mounted device, a medical health platform, a personal computer, a server computer, a handheld or laptop device, a mobile device (such as a mobile phone, a personal digital assistant (PDA) and a media player), a multi-processor system, a consumer electronic device, a small-size computer, a large-scale computer, and a distributed computing environment comprising any of above-mentioned systems or devices.

Although not required, the embodiment is described under the general background that “computer readable instructions” are executed by one or more electronic devices. The computer readable instructions can be distributed by a computer readable medium (discussed below). The computer readable instructions are implemented as program modules such as functions, objects, application programming interfaces (API) and data structures for executing specific tasks or implementing specific abstract data types. Typically, the functions of the computer readable instructions can be randomly combined or distributed in various environments.

FIG. 9 illustrates an example of an electronic device 912 comprising one or more embodiments of the picture optimizing device provided by the present invention. In one configuration, the electronic device 912 comprises at least one processing unit 916 and a memory 918. According to the exact configuration and type of the electronic device, the memory 918 can be a volatile memory (such as an RAM), a non-volatile memory (such as an ROM and a flash memory) or a certain combination of the volatile memory and the non-volatile memory. The configuration is shown as a dotted line 914 in FIG. 9.

In other embodiments, the electronic device 912 can comprise additional features and/or functions. For example, the device 912 can further comprise an additional storage apparatus (for example, removable and/or non-removable), and comprises, but is not limited to, a magnetic storage apparatus and an optical storage apparatus. The additional storage apparatus is illustrated as a storage apparatus 920 in FIG. 9. In one embodiment, the computer readable instructions for implementing one or more embodiments provided herein can be stored in the storage apparatus 920. The storage apparatus 920 can further store other computer readable instructions for implementing an operating system and an application. The computer readable instructions can be loaded into the memory 918 so as to be executed by, for example, the processing unit 916.

The term “computer readable medium” used herein comprises a computer storage medium. The computer storage medium comprises a volatile medium, a non-volatile medium, a removable medium and a non-removable medium implemented by using any method or technology for storing information such as the computer readable instructions or other data. The memory 918 and the storage apparatus 920 are examples of the computer storage medium. The computer storage medium comprises, but is not limited to, an RAM, an ROM, an EEPROM, a flash memory or other memory technologies, a CD-ROM, a digital video disk (DVD) or other optical storage apparatuses, a cassette tape, a magnetic tape, a magnetic disk storage apparatus or other magnetic storage devices, or any other media which can be used for storing desired information and can be accessed by the electronic device 912. Any of such computer storage media can be a part of the electronic device 912.

The electronic device 912 can further comprise a communication connection 926 allowing the electronic device 912 to communicate with other devices. The communication connection 926 can comprise, but not limited to, a modem, a network interface card (NIC), an integrated network interface, a radio frequency transmitter/receiver, an infrared port, a USB connection or other interfaces for connecting the electronic device 912 to other electronic devices. The communication connection 926 can comprise wired connection or wireless connection. The communication connection 926 is capable of transmitting and/or receiving a communication medium.

The term “computer readable medium” can comprise a communication medium. The communication medium typically comprises computer readable instructions or other data in “modulated data signals” such as carriers or other transmission mechanisms, and comprises any information delivery medium. The term “modulated data signals” can comprise such signals that one or more of signal features are set or changed in a manner of encoding information into the signals.

The electronic device 912 can comprise an input device 924 such as a keyboard, a mouse, a pen, a voice input device, a touch input device, an infrared camera, a video input device and/or any other input devices. The device 912 can further comprise an output device 922 such as one or more displays, loudspeakers, printers and/or any other output devices. The input device 924 and the output device 922 can be connected to the electronic device 912 by wired connection, wireless connection or any combination thereof. In one embodiment, an input device or an output device of another electronic device can be used as the input device 924 or the output device 922 of the electronic device 912.

Components of the electronic device 912 can be connected by various interconnections (such as a bus). Such interconnections can comprise a peripheral component interconnect (PCI) (such as a quick PCI), a universal serial bus (USB), a fire wire (IEEE 1394), an optical bus structure and the like. In another embodiment, the components of the electronic device 912 can be interconnected by a network. For example, the memory 918 can be composed of a plurality of physical memory units located on different physical positions and interconnected by the network.

It will be appreciated by those skilled in the art that storage devices for storing the computer readable instructions can be distributed across the network. For example, an electronic device 930 which can be accessed by a network 928 is capable of storing computer readable instructions for implementing one or more embodiments provided by the present invention. The electronic device 912 is capable of accessing the electronic device 930 and downloading a part or all of the computer readable instructions to be executed. Alternatively, the electronic device 912 is capable of downloading a plurality of computer readable instructions as required, or some instructions can be executed on the electronic device 912, and some instructions can be executed on the electronic device 930.

Various operations in the embodiments are provided herein. In one embodiment, the one or more operations can constitute one or more computer readable instructions stored in the computer readable medium, and a computing device will be enabled to execute the operations when the computer readable instructions are executed by the electronic device. The order of describing some or all of the operations should not be construed as implying that these operations have to be relevant to the order, and will be understood, by those skilled in the art, as an alternative order having benefits of this description. Moreover, it should be understood that not all the operations have to exist in each embodiment provided herein.

Moreover, although the present disclosure has been shown and described relative to one or more implementation modes, those skill in the art will envision equivalent variations and modifications based on reading and understanding of this description and the accompanying drawings. All of such modifications and variations are included in the present disclosure and are only limited by the scope of the appended claims. Particularly, with respect to various functions executed by the above-mentioned components (such as elements and resources), terms for describing such components are intended to correspond to any component (unless other indicated) for executing specified functions of the components (for example, the components are functionally equivalent), even if the structures of the components are different from the disclosed structures for executing the functions in an exemplary implementation mode of the present disclosure shown herein. In addition, although a specific feature in the present disclosure has been disclosed relative to only one in several implementation modes, the feature can be combined with one or more other features in other implementation modes which can be desired and beneficial for a given or specific application. Moreover, as for terms “comprising”, “having” and “containing” or variants thereof applied to the detailed description or claims, such terms means inclusion in a manner similar to the term “including”.

All the functional units in the embodiments of the present invention can be integrated in a processing module, or each unit separately and physically exists, or two or more units are integrated in a module. The above-mentioned integrated module can be achieved in a form of either hardware or a software functional module. If the integrated module is achieved in the form of the software functional module and is sold or used as an independent product, the integrated module can also be stored in a computer readable storage medium. The above-mentioned storage medium can be a read-only memory, a magnetic disk or an optical disk and the like. All of the above-mentioned devices and systems can execute the methods in the corresponding embodiments of the methods.

In summary, although the present invention has been disclosed as above in the embodiments, serial numbers in front of the embodiments are merely used for facilitating description, rather than limiting the order of all the embodiments of the present invention. Moreover, the above-mentioned embodiments are not intended to limit the present invention, those of ordinary skill in the art can make various changes and modifications without departing from the spirit and scope of the present invention, and therefore, the protection scope of the present invention is subject to the scope defined by the claims.

1. A picture optimizing method, comprising:
acquiring a target picture and a plurality of corresponding reference pictures, wherein the target picture and the reference pictures are relevant pictures in the same region;
dividing the target picture into a plurality of target picture alignment regions according to a set region size, wherein the adjacent target picture alignment regions have overlapping regions;
acquiring a reference picture alignment region, corresponding to each of the target picture alignment regions in the target picture, in each of the reference pictures and similarities of the target picture alignment regions and the corresponding reference picture alignment regions based on pixel grayscales of the target picture and the reference pictures; and
superposing and fusing the reference picture alignment regions of the plurality of reference pictures and the corresponding target picture alignment regions of the target picture based on the similarities so as to perform a noise reduction operation on the target picture.

2. The picture optimizing method of claim 1, wherein the step of acquiring the reference picture alignment region, corresponding to each of the target picture alignment regions in the target picture, in each of the reference pictures based on pixel grayscales of the target picture and the reference pictures comprises:
step A, using n set scales to generate n reduced target pictures according to the target picture, and to generate n reduced reference pictures according to the reference pictures;
step B, comparing pixel grayscales of reduced target pictures in a nth -level set scale with pixel grayscales of reduced reference pictures in the n^{th}-level set scale to acquire corresponding regions of the reduced target pictures in the n^{th}-level set scale and the reduced reference pictures in the nth -level set scale, wherein a m^{th}-level set scale is greater than a (m−1)^{th}-level set scale, and m and n are both positive integers;
step C, comparing pixel grayscales of reduced target pictures in a previous-level set scale with pixel grayscales of reduced reference pictures in the previous-level set scale in the corresponding regions of the reduced target pictures in the n^{th}-level set scale and the reduced reference pictures in the n^{th}-level set scale to acquire corresponding regions of the reduced target pictures in the previous-level set scale and the reduced reference pictures in the previous-level set scale, and repeating the step C until corresponding regions of reduced target pictures in a first-level set scale and reduced reference pictures in the first-level set scale are acquired; and
step D, comparing a pixel grayscale of each of the target picture alignment regions in the target picture with a pixel grayscale of each of the reference pictures in the corresponding regions of the reduced target pictures in the first-level set scale and the reduced reference pictures in the first-level set scale to acquire the reference picture alignment region, corresponding to each of the target picture alignment regions in the target picture, in each of the reference pictures.

3. The picture optimizing method of claim 1, wherein the plurality of target picture alignment regions have the same shape, and the overlapping regions of the adjacent target picture alignment regions are greater than or equal to 50% of an region of the target picture alignment regions.

4. The picture optimizing method of claim 1, wherein the target picture and the reference pictures are continuously shot pictures for the same region within a set time or a plurality of continuous video picture frames displaying the same region within a set time.

5. The picture optimizing method of claim 1, wherein the step of superposing and fusing the reference picture alignment regions of the plurality of reference pictures and the corresponding target picture alignment regions of the target picture based on the similarities comprises:
generating a superposing and fusing weight of the corresponding reference picture based on the similarities of the target picture alignment regions and the reference picture alignment region of each of the reference pictures; and
superposing and fusing the reference picture alignment regions of the plurality of reference pictures and the corresponding target picture alignment regions of the target picture based on the superposing and fusing weights of the reference pictures.

6. The picture optimizing method of claim 5, wherein the step of superposing and fusing the reference picture alignment regions of the plurality of reference pictures and the corresponding target picture alignment regions of the target picture based on the superposing and fusing weights of the reference pictures comprises:
performing a discrete Fourier transform on the corresponding target picture alignment regions of the target picture to acquire target Fourier frequency spectrums of the target picture alignment regions;
performing the discrete Fourier transform on the reference picture alignment regions of the reference pictures to acquire reference Fourier frequency spectrums of the reference picture alignment regions of the reference pictures;
performing weighted superposition on the target Fourier frequency spectrums of the target picture alignment regions by using the superposing and fusing weights of the reference pictures and the reference Fourier frequency spectrums of the reference picture alignment regions so as to obtain target Fourier frequency spectrums of superposed and fused target picture alignment regions; and
performing an inverse discrete Fourier transform on the target Fourier frequency spectrums of the superposed and fused target picture alignment regions to obtain the superposed and fused target picture alignment regions.

7. The picture optimizing method of claim 1, wherein the picture optimizing method further comprises:
acquiring a brightness distribution diagram of the target picture subjected to the noise reduction operation; and
performing a local brightness regulation on an region, where a brightness value is smaller than a set value, in the target picture subjected to the noise reduction operation.

8. A picture optimizing device, comprising:
a relevant picture acquisition module, used for acquiring a target picture and a plurality of corresponding reference pictures, wherein the target picture and the reference pictures are relevant pictures in the same region;
an region division module, used for dividing the target picture into a plurality of target picture alignment regions according to a set region size, wherein the adjacent target picture alignment regions have overlapping regions;
a comparison module, used for acquiring a reference picture alignment region, corresponding to each of the target picture alignment regions in the target picture, in each of the reference pictures and similarities of the target picture alignment regions and the corresponding reference picture alignment regions based on pixel grayscales of the target picture and the reference pictures; and
an optimization module, used for superposing and fusing the reference picture alignment regions of the plurality of reference pictures and the corresponding target picture alignment regions of the target picture based on the similarities so as to perform a noise reduction operation on the target picture.

9. The picture optimizing device of claim 8, wherein the comparison module, used for
step A, using n set scales to generate n reduced target pictures according to the target picture and to generate n reduced reference pictures according to the reference pictures;
step B, comparing pixel grayscales of reduced target pictures in a n^{th}-level set scale with pixel grayscales of reduced reference pictures in the n^{th}-level set scale to acquire corresponding regions of the reduced target pictures in the n^{th}-level set scale and the reduced reference pictures in the n^{th}-level set scale, wherein a m^{th}-level set scale is greater than a (m−1)^{th}-level set scale, and m and n are both positive integers;
step C, comparing pixel grayscales of reduced target pictures in a previous-level set scale with pixel grayscales of reduced reference pictures in the previous-level set scale in the corresponding regions of the reduced target pictures in the n^{th}-level set scale and the reduced reference pictures in the n^{th}-level set scale to acquire corresponding regions of the reduced target pictures in the previous-level set scale and the reduced reference pictures in the previous-level set scale, and repeating the step C until corresponding regions of reduced target pictures in a first-level set scale and reduced reference pictures in the first-level set scale are acquired; and
step D, comparing a pixel grayscale of each of the target picture alignment regions in the target picture with a pixel grayscale of each of the reference pictures in the corresponding regions of the reduced target pictures in the first-level set scale and the reduced reference pictures in the first-level set scale to acquire the reference picture alignment region, corresponding to each of the target picture alignment regions in the target picture, in each of the reference pictures.

10. The picture optimizing device of claim 8, wherein the plurality of target picture alignment regions have the same shape, and the overlapping regions of the adjacent target picture alignment regions are greater than or equal to 50% of the region of the target picture alignment regions.

11. The picture optimizing device of claim 8, wherein the target picture and the reference pictures are continuously shot pictures for the same region within a set time or a plurality of continuous video picture frames displaying the same region within a set time.

12. The picture optimizing device of claim 8, wherein the optimization module, used for
generating a superposing and fusing weight of the corresponding reference picture based on the similarities of the target picture alignment regions and the reference picture alignment region of each of the reference pictures; and
superposing and fusing the reference picture alignment regions of the plurality of reference pictures and the corresponding target picture alignment regions of the target picture based on the superposing and fusing weights of the reference pictures.

13. The picture optimizing device of claim 12, wherein the optimization module, used for
performing a discrete Fourier transform on the corresponding target picture alignment regions of the target picture to acquire target Fourier frequency spectrums of the target picture alignment regions;
performing the discrete Fourier transform on the reference picture alignment regions of the reference pictures to acquire reference Fourier frequency spectrums of the reference picture alignment regions of the reference pictures;
performing weighted superposition on the target Fourier frequency spectrums of the target picture alignment regions by using the superposing and fusing weights of the reference pictures and the reference Fourier frequency spectrums of the reference picture alignment regions so as to obtain target Fourier frequency spectrums of superposed and fused target picture alignment regions; and
performing an inverse discrete Fourier transform on the target Fourier frequency spectrums of the superposed and fused target picture alignment regions to obtain the superposed and fused target picture alignment regions.

14. The picture optimizing device of claim 8, wherein the optimization module, further used for
acquiring a brightness distribution diagram of the target picture subjected to the noise reduction operation; and
performing a local brightness regulation on an region, where a brightness value is smaller than a set value, in the target picture subjected to the noise reduction operation.

15. A computer readable storage medium, storing instructions executable by a processor, wherein the processor executes the instructions to provide a picture optimizing method, comprising:
acquiring a target picture and a plurality of corresponding reference pictures, wherein the target picture and the reference pictures are relevant pictures in the same region;
dividing the target picture into a plurality of target picture alignment regions according to a set region size, wherein the adjacent target picture alignment regions have overlapping regions;
acquiring a reference picture alignment region, corresponding to each of the target picture alignment regions in the target picture, in each of the reference pictures and similarities of the target picture alignment regions and the corresponding reference picture alignment regions based on pixel grayscales of the target picture and the reference pictures; and
superposing and fusing the reference picture alignment regions of the plurality of reference pictures and the corresponding target picture alignment regions of the target picture based on the similarities so as to perform a noise reduction operation on the target picture.
